(19) United States
(12) Patent Application Publication
(10) Pub. No.: US 2011/0141850 A1
(43) Pub. Date: Jun. 16, 2011

(54) Electromagnetic system for timing synchronization and location determination for seismic sensing systems having autonomous (NODAL) recording units

(75) Inventors: Gary Lee Scott, Richmond, TX (US); Andrew Christopher Clark, Gonzales, TX (US)

(73) Assignee: PGS Onshore, Inc.

(21) Appl. No.: 12/653,493

(22) Filed: Dec. 15, 2009

(51) Int. Cl. G01V 1/04

(52) U.S. Cl. 367/50

(57) ABSTRACT

A synchronization system for a nodal geophysical data recorder includes an electromagnetic transmitter associated with a master recording unit. The master unit includes devices for determining time and geodetic position from an external reference. The transmitter includes a code generator to cause transmission of a time synchronization signal as a coded sequence. The transmitter is configured to induce an electromagnetic field in at least one of subsurface rock formations and a body of water. At least one nodal geophysical data recorder includes at least one geophysical data sensor. The at least one sensor has measurements therefrom stored in a data storage device associated with the recorder wherein the recorder includes a clock for time indexing the stored data measurements. The recorder includes a receiver for detecting and decoding the time synchronization signal in the coded sequence to synchronize the clock with the synchronization signal.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of seismic signal acquisition and recording. More specifically, the invention relates to systems for signal recording synchronization and recorder position detection wherein the seismic recorders are autonomous.

2. Background Art

Geophysical data recording such as seismic signal recording includes the use of autonomous (“nodal”) signal recorders disposed at spaced apart positions above an area of the Earth's surface to be surveyed. A nodal signal recorder may be connected to one or more individual seismic sensors. Typically, a nodal recorder includes a clock or similar timing device and a data storage device. The clock or timing device enables indexing the signals that are recorded to a known time reference, such as the actuation time of a seismic energy source. When such surveys are conducted on the land surface, and there are few physical obstructions to detection of radio frequency signals by the nodal recorder, the nodal recorder may be configured to receive time reference signals from a global positioning system (GPS) satellite, and may receive such signals from a plurality of GPS satellites to determine the precise geodetic location of the nodal recorder. Such GPS timing and location techniques are known in the art. It is also known in the art to transmit timing reference signals from a master recording unit by a radio frequency communication system. The master recording unit may include a controller to actuate the seismic energy source, such that the nodal recorders are time synchronized to the actuation time of the source, even if not referenced to absolute time.

For conducting seismic surveys where obstructions to communication by radio frequency exist, for example in dense jungle, or in water covered areas, it is impracticable to synchronize nodal recording units or determine their geodetic locations using techniques known in the art. Direct cable connection could be used, but may be impracticable because of the terrain and/or the distances from the master recording unit to some of the nodal recorders.

There exists a need to synchronize nodal geophysical data recording devices and determine their geodetic positions without the need to use radio frequency communication or direct cable connection.

### SUMMARY OF THE INVENTION

A synchronization system for a nodal geophysical data recorder according to one aspect of the invention includes an electromagnetic transmitter associated with a master recording unit. The master unit includes devices for determining time and geodetic position from an external reference. The transmitter includes a code generator to cause transmission of a time synchronization signal as a coded sequence. The transmitter is configured to induce an electromagnetic field in at least one of subsurface rock formations and a body of water. At least one nodal geophysical data recorder includes at least one geophysical data sensor. The at least one sensor has measurements therefrom stored in a data storage device associated with the recorder wherein the recorder includes a clock for time indexing the stored data measurements. The recorder includes a receiver for detecting and decoding the time synchronization signal in the coded sequence to synchronize the clock with the synchronization signal.

A method for geophysical surveying according to another aspect of the invention includes disposing at least one nodal data recorder proximate an area of the Earth's subsurface to be evaluated. The nodal recorder has associated therewith at least one geophysical sensor and a recorder. At selected times a geophysical energy source is actuated. Response of the at least one sensor in the respective nodal recorder is recorded. A time of recording of the sensor response is indexed. At selected times, a clock associated with the nodal recorder is synchronized by imparting a coded sequence electromagnetic field into the subsurface from a position proximate the surface and detecting the electromagnetic field at the nodal recorder. A time synchronization signal is obtained by cross correlating the detected electromagnetic field at the recorder with a reference copy of the coded sequence stored in each nodal recorder. The synchronization signal is used to synchronize the clock.

In one example, the coded sequence may be further encoded to include data. In one example a transmission time of the coded sequence is further encoded. Travel time of the coded sequence is determined by detecting the coded sequence time index and determining a difference therebetween and a time determined at the nodal recorder. Travel times may be used from transmitters located at a plurality of positions to determine the geodetic position of each nodal recorder.

Other aspects and advantages of the invention will be apparent from the following description and the appended claims.

### BRIEF DESCRIPTION OF THE DRAWINGS

FIG. 1 shows a seismic data recording system using nodal recording units and a master recording unit.

FIG. 2 shows an example of a nodal recording unit.

FIGS. 3A and 3B show an example of including data along with timing information by reversing polarity of the coded sequence.

### DETAILED DESCRIPTION

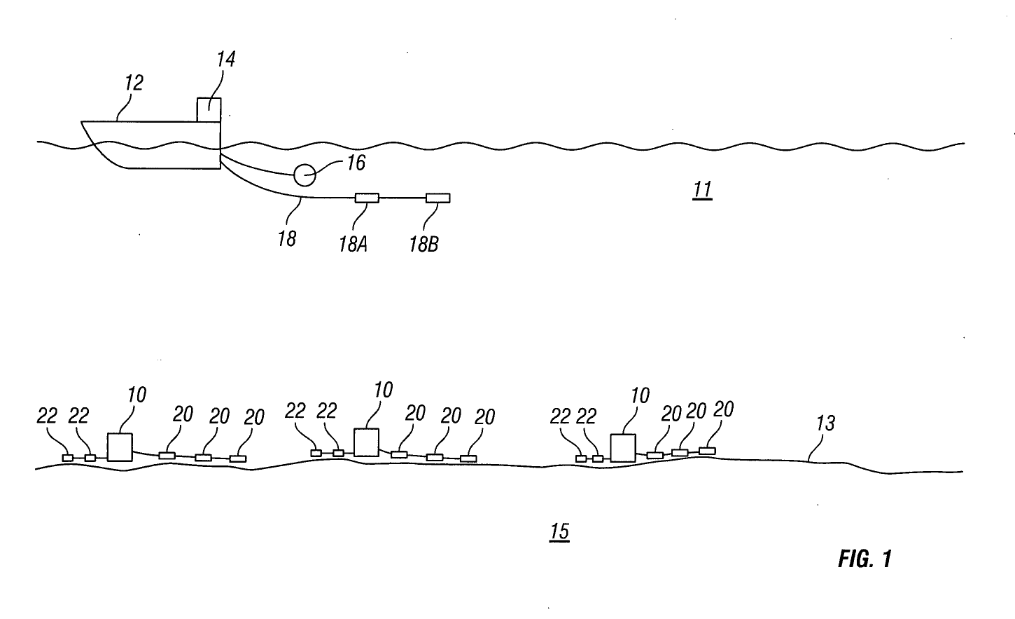

An example geophysical data recording system using nodal data recorders is shown schematically in FIG. 1. The system in the present example is used to survey rock formations 15 below the bottom 13 of a body of water 11. It will be appreciated by those skilled in the art that corresponding configurations of the principal components of the system in FIG. 1 may be devised for use on the land surface, and these will be noted where appropriate.

A survey vessel 12 moves along the surface of the water 11. The survey vessel 12 includes equipment shown generally at 14 and for convenience referred to as a “master recording unit.” The master recording unit 14 may include components such as the following (none shown separately in FIG. 1): a controller for actuating a geophysical energy source 16, such as a seismic energy source, towed by the survey vessel 12 or by another vessel (not shown) at selected times; a global positioning system (GPS) receiver for detecting absolute time and geodetic position signals; a data recording and processing computer; and an electromagnetic transmitter. The electromagnetic transmitter may be a source of electric current that is periodically applied to an electromagnetic transmitter antenna 18. The electromagnetic transmitter antenna 18 in the present example may be a pair of spaced apart electrodes 18A, 18B disposed in the water. When current passes across the electrodes 18A, 18B in the water 11, a time varying electric field is generated. In other examples, the transmitter antenna 18 may be a wire loop or coil, such that the electric current induces a time varying magnetic field. Such devices are described, for example, in U.S. Patent Application Publication No. 2009/0216454 by Ziolkowski et al. As will be explained further below, the current for the transmitter antenna 18 may be generated by the master recording unit 14 in a coded sequence of switching events, the switching events being, for example, switching current on, switching current off, or reversing current polarity. The electromagnetic transmitter antenna may also be implemented on the land surface such as by disposing a wire loop on the ground or implanting electrodes into the ground surface.

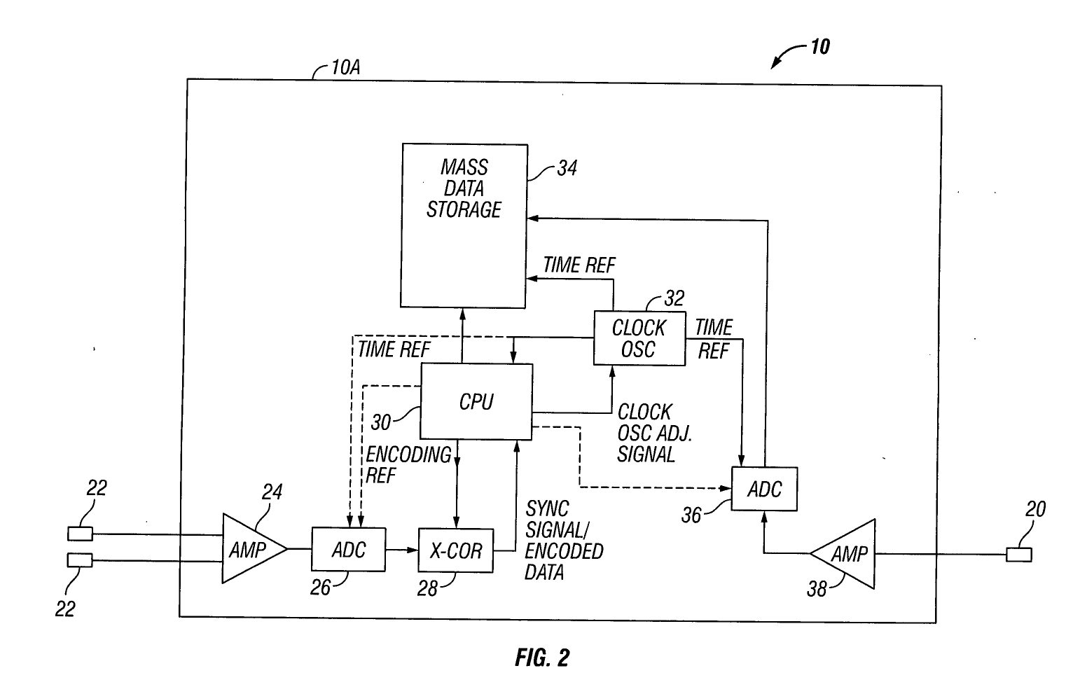

A plurality of nodal signal recorders 10 may be disposed on the water bottom 13 at spaced apart positions. The nodal recorders 10, an example of which will be explained in more detail with reference to FIG. 2, detect signals generated by one or more sensors 20 coupled to each such recorder 10. The sensors 20 may be any type of sensor known in the art associated with subsurface geophysical surveying, including, without limitation seismic sensors such as pressure or pressure time gradient responsive sensors such as hydrophones, or motion responsive sensors such as geophones or accelerometers. The sensors 20 may include substantially collocated hydrophones, and a plurality of motion responsive sensors oriented along different (usually orthogonal) directions. Such seismic sensor configurations are known in the art for ocean bottom cables. The sensors 20 may also be wire loops or coils, electrodes or magnetometers, for example. The number of nodal signal recorders 10 used in any implementation is not a limit on the scope of the present invention.

Each nodal signal recorder 10 may also have associated therewith an electromagnetic receiver antenna 22, for example, a pair of spaced apart electrodes as shown in FIG. 1. The receiver antenna 22 may also be a wire loop or coil as is the case for the transmitter antenna 18. The electromagnetic receiver antenna 22 will have induced therein a voltage corresponding to the time varying electromagnetic field induced in the water 11 and in the subsurface formations 15 by the time varying electric or magnetic field from the transmitter 18.

During some types of geophysical surveying, the energy source 16 is actuated at selected times, and the signals detected by the sensors 20 are recorded by the respective nodal signal recorders 10. The recordings are typically indexed to the actuation time of the energy source 16, so that travel time of the detected energy (e.g., seismic energy) may be used to infer certain properties of the subsurface formations 15 such as the structure thereof.

In order to ensure accurate time indexing, it is desirable to synchronize the nodal signal recorders 10 with the master recording unit 14 or other time reference. In the present invention, signals transmitted by the electromagnetic transmitter 18 may be used to transmit clock synchronizing (time reference) signals, and other information such as geodetic position of the transmitter antenna 18 and/or the absolute time of the transmission of the synchronizing signals, so that the geodetic position of each nodal signal recorder 10 may be determined.

An example of one of the nodal signal recorders 10 is shown in more detail in FIG. 2. Electronic components of the nodal signal recorder 10 may be enclosed in a pressure resistant housing 10A for use in the water as explained with reference to FIG. 1. A first preamplifier 38 may be connected at its input to the sensor 20. Only one sensor and preamplifier is shown in FIG. 2 for clarity of the illustration. If multiple sensors are used, a plurality of such first preamplifiers may be used, or a multiplexer may be included at the input of a single preamplifier. The output of the first preamplifier 38 may be digitized in a first analog to digital converter (ADC) 36. Digitized signals from the first ADC 36 may be conducted to a data mass storage unit 34, which may be, for example, a hard drive or solid state memory or other data storage device known in the art. The data mass storage unit 34 obtains time reference (indexing) signals from a master clock oscillator 32. Operation of the foregoing components may be controlled by a central processing unit (CPU) 30 which may be a microprocessor or similar device. The foregoing devices may be supplied by a battery or other electric energy storage device (not shown for clarity).

The electromagnetic receiver antenna 22 (electrodes) is shown coupled to the input of a second preamplifier 24, the signals from which may be digitized in a second ADC 26. In the present example, the CPU 30 may store a version or copy of the coded sequence to be applied to the electromagnetic transmitter antenna (18 in FIG. 1). The version or copy of the coded sequence is conducted to an input of a cross correlator 28 (in some examples, the function of the cross correlator may be performed by or in the CPU 30). Output of the second ADC 26 may also be conducted to an input of the cross correlator 28. Output of the cross correlator 28 (cross correlation function) represents a time synchronization signal, and in some examples may also include encoded data. The time synchronization signals may be determined, for example, when the value of a cross-correlation function (output of the cross correlator) reaches a maximum or peak. The time synchronization signal may be conducted to the CPU 30, wherein a time difference between the time of the detected synchronization signals and the time determined by the clock oscillator 32 is calculated. For example, the CPU 30 may be programmed to expect detection of the synchronization signal repeatedly at a selected time interval. If in any one or more detections of the synchronization signal the synchronization signal detection time is different from the expected detection time as calculated, for example, in the CPU 30, the difference may be used to cause a correction or adjustment in the clock oscillator 32 frequency so that subsequent time differences are reduced.

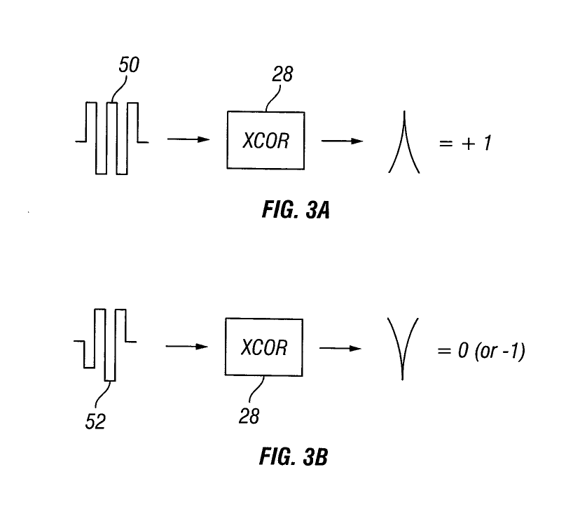

By switching the electromagnetic transmitter (18 in FIG. 1) current on and off, and/or by reversing the current polarity, the electrical current, and thereby the induced electromagnetic field, may be encoded, or modulated, so that at a distant location the electromagnetic field may be detected by the receiver antenna 22, amplified, and decoded to retrieve additional data or information further encoded onto the original encoded sequence. In one example, the further encoding of information may be performed by inverting the polarity of the encoded sequence in its entirety. Referring to FIG. 3A, an example coded sequence as detected in the nodal recording unit is shown at 50. After passing through the cross correlator 28, an output signal may be in the form of a positive peak at the synchronization time. If, as in FIG. 3B the entire coded sequence is inversely polarized, a negative correlation peak will be output from the cross correlator 28 at the reference time. The foregoing procedure may be operated to send a sequence of binary 1s and 0s (or −1s) from the master recording unit (14 in FIG. 1) or similar device. The 1s and 0s may be used to encode any data susceptible to transmission in such form. Specific examples will be explained below.

The further encoding may convey information such as precise moments in time through encoded “time marks”, and other information encoded in such a fashion as to enhance signal to noise level and the retrieval of the encoded data in poor signal to noise ratio environments.

Transmission of an encoded sequence at a known moment in time enables the nodal recorder (10 in FIG. 1) to decode the information using correlation or other such techniques to recognize the coded sequence as being detected at a precise moment in time, and having been transmitted at another and different precise moment in time. By calculating the difference between such times the distance between the transmitter and the nodal recorder may be calculated. The time of the transmission may be at a predetermined moment, or the precise time of the transmission may be encoded in the transmission as explained above using a plurality of coded sequences having polarity representing 1s and 0s and decoded along with the time synchronization signal. Deployment of multiple electromagnetic transmitters at known geodetic locations around and through the area of deployment of the nodal recorders will enable known triangulation positioning techniques to determine the exact geodetic position of each nodal recorder by decoding therein the transmitted signal and calculating the travel time of the signal transmitted from each of the different electromagnetic transmitter positions.

The foregoing nodal recorder position determination may also be performed by deploying electromagnetic transmitters on vessels or vehicles that travel through the area where the nodal recorders are located. The transmitters each transmit a signal encoded with the precise time and location at the moment of the transmission. In some examples, local environment information such as water depth at the vessel location may be encoded in the transmitted electromagnetic signal. It will be appreciated that the vessel shown in FIG. 1 may be operated so that the electromagnetic transmitter (18 in FIG. 1) is positioned at a plurality of locations while transmitting encoded sequence electromagnetic signals.

The transmitter, or each electromagnetic transmitter if a plurality of transmitters is used, may obtain information concerning its geodetic position and absolute time from external reference signals received, for example from global positioning system (GPS) satellites or other navigational radio aids deployed in the area.

Transmission encoding techniques may be used such as a scheme of predetermined precise transmission times and codes such that each transmitter is excited at a predetermined time, and each nodal recorder will have stored therein such times. Certain components of each nodal recorder can be switched on within a selected time range of the predetermined times and detect each such electromagnetic signal. At other times, the same components of the nodal recorder, for example the preamplifiers and ADCs may be, switched off to preserve battery life. Another purpose for detecting electromagnetic signal only within a selected time range of the predetermined times is to enable better results from stacking signal from a plurality of detection intervals under conditions of low signal to noise ratio. By limiting the detection time to specific time ranges about the predetermined times, it is more likely that signal to noise ratio will be increased by stacking a plurality of detected signals.

As explained above, and referring once again to FIG. 2, such transmitted codes may be repeated a predetermined number of times at predetermined time intervals. The electromagnetic receiver output signal during each coded sequence time period may be digitized in the first ADC 26, captured and stored, for example in the mass data storage unit 34. The electromagnetic receiver output during each successive period can also be digitized, in the first ADC 26, and added to the sum of the previous periods and again stored. The process of summing the receiver output signal over a predetermined number of periods is such that the repeated synchronization signal transmissions will be added together synchronously, enhancing the level of the received synchronization signals and reducing background electrical noises.

When required, the foregoing processes may used either together or individually A tradeoff is that repeating transmission of the coded sequence more frequently and summing the results in the mass data storage increases the capability to detect smaller and smaller coded signals, however, the length of time required to detect, decode and recognize the time synchronization signal and amount of data storage required increases correspondingly.

To obtain recognition of a synchronization time using repetitive transmissions, the transmissions of successive synchronization signals may be scheduled to occur at a series of predetermined times, with each transmission coded as “T” minus X milliseconds counting to the time mark “T” minus zero milliseconds. Each synchronization time coded sequence can also contain information (e.g., by polarity reversal as explained above) for the exact time at which “T” is predetermined to occur, encoded in each transmission. The occurrence of synchronization time T is compared to the predetermined time for each particular synchronization time to occur. Since it is expected that the detected synchronization time will be very near the predetermined time, or off by only one or more intervals, the CPU 30 may be configured, for example, so that when the synchronization time is determined to be within, for example, a half an interval the mark is considered to be valid. “Interval” in this context means the amount of time to transmit one bit of the encoding of the coded synchronization signal.

An example is to schedule to transmit the synchronization signal 10 times at 100 millisecond intervals beginning one second prior the desired sync 0 time “T−0.” Each transmission of the synchronization signal may be further encoded (explained above) to contain the information of “T minus XXX ms” followed by the unique synchronization code describing the moment of the “T” event. Each transmission “word” may be scheduled as T minus 900 ms, then T minus 800 ms, etc., to T minus 0 ms, with T being the moment of synchronization. The moment T may be represented by a unique digital code transmitted at a precise time, so the codes may be summed. For the codes to be summed they must occur at the expected moments in time within a small allowable drift in timing. Drift in time up to one half of one of the bits of the word (one half an interval) may be considered acceptable and the summation process will still work. Because the synchronization time code in this example includes a transmitted word of the predicted time of the occurrence, the CPU 30 compares the nodal recorder's expected time of occurrence (determined from the clock oscillator 32 value) to the time word in the detected synchronization signal, and if the timing between the two is within a selected tolerance, the next synchronization signal (T plus X milliseconds) will be used to adjust the clock oscillator 32. If the difference between the expected time of occurrence and the time word in the detected synchronization signal exceeds the selected tolerance, the detected time word will not be used to adjust the clock oscillator 32. For example, if the difference exceeds the selected tolerance, it may be that the synchronization signal became corrupted.

During survey conditions where electromagnetic signals have very good signal to noise ratios (e.g., on land), the foregoing stacking and further encoding techniques may not be used and a synchronization signal may be transmitted, for example with a single transmission pulse or encoded sequence transmitted at selectable time periods.

The clock oscillator 32, if of types known in the art, can be accurate enough such that between synchronization signal transmissions an accuracy of within 300 microseconds of absolute time may be maintained over a period of 12 hours. In such cases the electromagnetic synchronization technique described above may only need to occur as infrequently as once per several hours. The rate of synchronization may be determined by the amount of time error detected in each nodal data recorder 10 at each synchronization time detection. The rate of synchronization may vary from every few minutes to several hours between synchronization events depending on the accuracy of any individual clock oscillator 32. A record of the amount of required adjustment may be stored in the mass data storage unit 34 and reported as the nodal recorder 10 is retrieved and adjustments and or repairs may be made as is determined as necessary from the records.

It is within the scope of the present invention, as explained above, to further encode the coded synchronization time signal with other data. In one example, the other data may include the exact transmission time of the coded signal. Such time may be recovered at each nodal recording unit 10 during decoding. The recovered exact transmission time may be compared to the local time as measured by the CPU 30 from the clock oscillator 32. Differences between the exact transmission time and the local time at the nodal recorder 10 will represent the electromagnetic signal transmission time. In one example, the vessel 12 may be move to a plurality of locations, and the transmission time determination process repeated. Using transmission or travel times from signals transmitted from several different directions, a location of each nodal recorder 10 may be precisely determined. In other examples, the same function may be performed by operating a plurality of electromagnetic signal transmitters at known locations.

Using an electromagnetic synchronization system as described herein may enable more precise time indexing of geophysical data recordings made over substantial time periods without the need to physically access each data recorder. Such precise time indexing may be performed without the need for direct electrical and/or optical connection between a master recording unit and remote data recorders, and under conditions where transmission of a radio signal between the master recording unit and the remote recorders is impracticable.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A synchronization system for a nodal geophysical data recorder, comprising:
an electromagnetic transmitter disposed proximate a portion of the Earth's subsurface to be evaluated, the transmitter including devices for determining absolute time and geodetic position from an external reference, the electromagnetic transmitter including a code generator to cause transmission of a time synchronization signal in the form of a coded sequence, the transmitter configured to cause the transmission by inducing an electromagnetic field in the subsurface; and
at least one nodal geophysical data recorder disposed proximate the subsurface portion, the at least one nodal data recorder associated with at least one geophysical sensor, the at least one sensor having measurements therefrom stored in a data storage device associated with the recorder, the recorder including a clock for time indexing the stored data measurements, the recorder including an electromagnetic receiver for detecting and decoding the time synchronization signal in the coded sequence to synchronize the clock with the synchronization signal.

2. The system of claim 1 wherein the at least one nodal recorder comprises a cross correlator in signal communication with the electromagnetic receiver.

3. The system of claim 1 wherein the at least one nodal recorder comprises a data processor configured to determine a time difference between detection times of each of a plurality of time markers detected from the output of the cross correlator and each of a preprogrammed series of time intervals.

4. The system of claim 1 wherein the data processor is configured to adjust a clock oscillator in functional communication with the data storage device in response to differences in time determined between the detected time markers and the preprogrammed sequence.

5. The system of claim 1 wherein the at least one geophysical sensor comprises a seismic sensor.

6. The system of claim 3 wherein the data processor is configured to detect data communicated in the coded sequence by determining a polarity of the output of the cross correlator.

7. The system of claim 6 wherein the data comprises time of transmission of the encoded sequence.

8. The system of claim 7 wherein the data processor is configured to determine a travel time of the encoded sequence by decoding the transmission time and comparing to time at the data processor.

9. A method for geophysical surveying, comprising:
disposing at least one nodal data recorder proximate an area of the Earth's subsurface to be evaluated, the at least one nodal recorder having associated therewith at least one geophysical sensor;
at selected times actuating a geophysical energy source;
recording response of the at least one sensor in the at least one nodal recorder;
indexing a time of recording of the sensor response;
at selected times, synchronizing a clock associated with the at least one nodal recorder by imparting a coded sequence electromagnetic field into the subsurface and detecting the electromagnetic field at each nodal recorder;
cross correlating the detected electromagnetic field with a reference copy of the coded sequence stored in the at least one nodal recorder to obtain a time synchronization signal; and
using the time synchronization signal to synchronize the clock.

10. The method of claim 9 wherein the synchronizing comprises transmitting a plurality of coded sequences in a predetermined time schedule and determining differences between detected synchronization signals and a copy of the predetermined time schedule stored in the at least one nodal recorder.

11. The method of claim 9 further comprising communicating data to the at least one nodal recorder by inverting a polarity of the coded sequence.

12. The method of claim 9 wherein the data comprises transmission time of the electromagnetic signal.

13. The method of claim 12 further comprising determining a travel time of the electromagnetic signal from the transmission time.

14. The method of claim 13 further comprising determining travel times of electromagnetic signals transmitted from a plurality of locations, and determining a geodetic position of the at least one nodal recorder from the travel times.

15. The method of claim 9 wherein the geophysical sensor comprises a seismic sensor.

16. The method of claim 9 wherein the geophysical energy source comprises a seismic energy source.

17. The method of claim 9 wherein the electromagnetic field is generated by imparting a voltage across a pair of spaced apart electrodes.

18. The method of claim 9 wherein the detecting the electromagnetic field includes measuring a voltage imparted across a pair of spaced apart electrodes.

19. The method of claim 9 further comprising switching on selected components of the at least one nodal recorder within a predetermined range of a time of transmission of the electromagnetic field and switching the selected components off after a predetermined range of the transmission time.

20. The method of claim 9 further comprising:
transmitting a plurality of coded sequence electromagnetic fields into the subsurface in a predetermined schedule;
detecting the plurality of coded sequence electromagnetic fields in the at least one nodal recorder; and
summing the detected coded sequences.
